(19) United States
(12) Patent Application Publication
(10) Pub. No.: US 2021/0239795 A1
(43) Pub. Date: Aug. 5, 2021

(54) Sensor arrangement comprising a cover element and method for producing the cover element

(71) Applicant: Webasto SE, Stockdorf (DE)

(72) Inventors: Alexander KILIAS, Stockdorf (DE); Andrea KRAMER, Stockdorf (DE); Dirk LEGLER, Stockdorf (DE)

(21) Appl. No.: 17/049,135

(22) PCT Filed: Apr. 23, 2019
(86) PCT No.: PCT/EP2019/060332

§ 371 Date: Oct. 20, 2020

(30) Foreign Application Priority Data
Apr. 24, 2018 (DE) 10 2018 109 884.7

(51) Int. Cl. G01S 7/40; G01S 7/481; G01S 17/931; B60S 1/08

(52) U.S. Cl. CPC G01S 7/4047; B60S 1/0848; G01S 17/931; G01S 7/4813

(57) ABSTRACT

A sensor arrangement of a motor vehicle, the sensor arrangement having a sensor element emitting electromagnetic radiation in a measuring direction to determine a measurement signal, and a cover element disposed in front of the sensor element in the measuring direction and being an injection-molded plastic part permeable to the electro-magnetic radiation and having an outer side facing a vehicle environment and an inner side facing the sensor element, and a heating means comprising conductor tracks. The conductor tracks can be applied to a film formed to the inner side of the cover element during production of the cover element by injection-molding, the film with the conductor tracks thus forming an insert of the injection-molded cover element, the conductor tracks being located on the side of the film facing away from the sensor element.

The invention relates to a sensor arrangement of a motor vehicle comprising the features of the preamble of claim 1 and to a method for producing a cover element of a sensor arrangement.

A sensor arrangement of this kind is known from practice and can be used in a motor vehicle to monitor a vehicle environment. For this purpose, the sensor arrangement comprises a sensor element emitting electromagnetic radiation in the form of laser radiation, for example, in one or more specific directions, allowing a system of the vehicle to detect and process the vehicle environment, including the course of the road, the traffic situation and the like. The sensor element is disposed in the area of a roof of the vehicle or in the area of the front end of the vehicle, for example, and is positioned behind a cover element permeable to the electromagnetic radiation emitted by the sensor element. The cover element can be made of a plastic material. To keep the cover element permeable to the electromagnetic radiation also in bad weather conditions and to be able to de-ice it, a heating means can be provided which comprises conductor tracks disposed on the inner side of the cover element, which faces the sensor element. In the case of the known sensor arrangement, the conductor tracks of the heating means are exposed on the inner side of the cover element. This means they might be exposed to environmental conditions such as humidity, which can affect their functioning.

The object of the invention is to provide a sensor arrangement configured according to the state of the art which ensures high functional reliability of the heating means and to provide a method for producing a cover element of such a sensor arrangement.

According to the invention, this object is attained by the sensor arrangement having the features of claim 1.

The cover element of the sensor arrangement according to the invention, which is disposed in front of the sensor element and is transparent for the electromagnetic radiation emitted by the sensor element, is provided with a film on its inner side, i.e., on its side facing the sensor element, said film being provided with the conductor tracks on the side facing away from the sensor element, the conductor tracks thus being protected by the film and not being exposed to environmental conditions or weather conditions. The conductor tracks are located close to the outer side of the cover element, which faces the vehicle environment and may have to be de-iced.

In a preferred embodiment of the sensor arrangement according to the invention, the film has an anti-reflection coating on its side facing away from the conductor tracks and thus facing the sensor element in order to increase the quality of the measurement signal detected by the sensor arrangement and to ensure that the electromagnetic radiation emitted by the sensor can pass through the cover element unhindered.

The anti-reflection coating, which is applied to the film before the film is connected to the cover element, is in particular specific to the electromagnetic radiation used by the sensor arrangement according to the invention. For example, the anti-reflection coating is made of a material produced based on polysiloxane. Alternatively, the anti-reflection coating can be made from an indium compound.

The anti-reflection coating is advantageously reflective for electromagnetic radiation having a wavelength outside of a specific wavelength spectrum. The wavelength spectrum for which the anti-reflection coating is anti-reflective covers the wavelength(s) of the radiation emitted by the sensor element.

Advantageously, the anti-reflection coating has a surface structure in order to increase its effectiveness. The surface structure is produced by plasma etching, for example, and can have what is referred to as a moth-eye structure, which is a nanostructure consisting of a tight array of small cones.

The cover element of the sensor arrangement according to the invention can in particular be made of a polycarbonate material or of another material suitable for the application in question.

Accordingly, in a preferred embodiment, the film of the sensor arrangement according to the invention comprises or is made of a polycarbonate material.

In an advantageous embodiment of the sensor arrangement according to the invention, the cover element is provided with a protective coating on its outer side, which faces the vehicle environment, in order to be able to protect the cover element against damage and wear. The protective coating can consist of a paint system of which one or two layers are applied and which offers protection against scratching, weather and/or chemicals. The paint system used can be a thermally hardening paint system or a paint system hardened by means of UV radiation. The paint system may be applied by spraying or by flow coating.

Advantageously, the protective coating has a refractive index less than that of the injection-molded plastic material of the cover element. This can improve the transmission behavior of the cover element.

The sensor arrangement according to the invention can basically be disposed in any place on a motor vehicle and can be designed for different purposes. For example, the sensor arrangement is integrated in a vehicle roof and forms part of a system for autonomous or semi-autonomous driving of the vehicle in question. In this case, the cover element forms an outer skin element of the vehicle roof, i.e., in particular a fixed roof portion immobile relative to the vehicle body. However, the sensor arrangement may also be placed on a vehicle roof in the manner of a dome. In this case, the cover element forms at least a part of a housing of the sensor arrangement, which accommodates the sensor element.

In an alternative embodiment, the cover element forms an outer skin element of a vehicle front or of a vehicle rear. In this case, the sensor arrangement can also be part of a distance control system, a parking assistance system and/or another safety feature of the vehicle in question.

The invention also relates to a method for producing a cover element of a sensor arrangement of a motor vehicle, the method comprising the following steps:
providing a film having a first side and a second side;
applying conductor tracks to the first side of the film;
introducing the film with the conductor tracks into a mold cavity of an injection mold;
filling the mold cavity of the injection mold with a plastic material;
hardening the plastic material in the mold cavity to form the cover element having the film molded thereon; and
demolding the cover element having the film molded thereon.

In a preferred embodiment of the method according to the invention, an anti-reflection coating is applied to the second side of the film before the film is inserted into the mold cavity. The anti-reflection coating can be applied before or after the application of the conductor track to the other side of the film.

The conductor tracks can be applied to the film by any technique. Printing techniques, embossing techniques or transfer techniques may be employed for this purpose. Specific examples include screen printing techniques, dispensing techniques, hot stamping techniques and transfer printing techniques. Moreover, suitable hardening techniques, such as laser hardening techniques, can be employed to harden the conductor tracks.

The anti-reflection coating is preferably extensively applied to the second side of the film by means of a doctor blade, by screen printing or by coextrusion, for example. Subsequently, the anti-reflection coating can be subjected to a structuring process, such as a plasma etching process, to increase the anti-reflection effect.

Furthermore, the conductor tracks can be applied to a broad film web or to a film cut whose dimensions correspond to the dimensions of the film or which corresponds to the film which will be inserted into the mold cavity.

When the cover element is injection-molded, the film or the film cut is overmolded in such a manner that the side on which the conductor tracks are disposed is overmolded with the plastic material. The other side of the film, on which the anti-reflection coating is preferably disposed, stays free of plastic material.

The method according to the invention is in particular designed in such a manner that the film is unwound from a first roller and the anti-reflection coating is then extensively applied to one side of the film. Subsequently, the film is wound onto a second roller. In another method step, the film is then unwound from the second roller and is provided with the conductor tracks and with contact points for being electrically connected to an electrical system of a vehicle on the side facing away from the anti-reflection coating. Then the film can be die-cut so as to produce a film cut which has the conductor tracks and which is then inserted into the injection mold, in particular by means of a robot, in whose mold cavity it is overmolded with the plastic material.

After demolding of the cover element from the mold cavity of the injection mold, the cover element is preferably provided with a protective coating on the side facing away from the film or film arrangement to protect it against scratching, weather conditions and chemicals.

Other advantages and advantageous embodiments of the subject matter of the invention are apparent from the description, the drawing and the claims.

Exemplary embodiments of a sensor arrangement according to the invention and a method for producing a cover element of the sensor arrangement are illustrated in the drawing in a schematically simplified manner and will be explained in more detail in the following description.

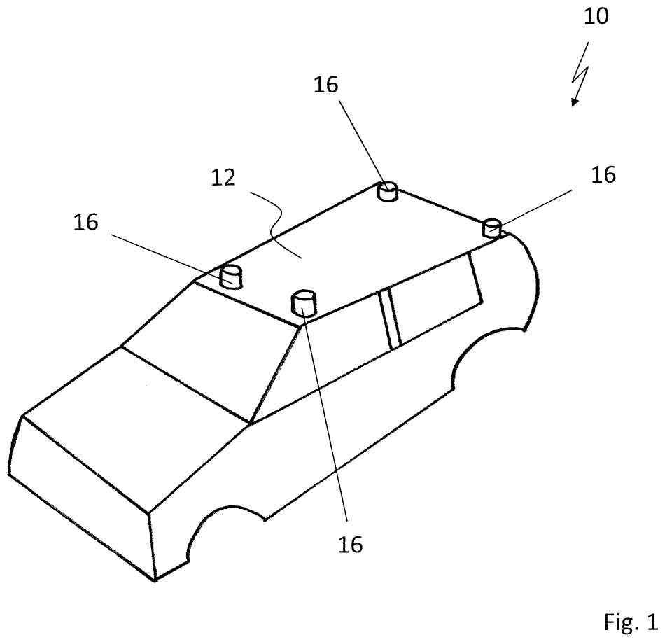

FIG. 1 is a perspective view of a vehicle having sensor arrangements according to the invention integrated in the roof;

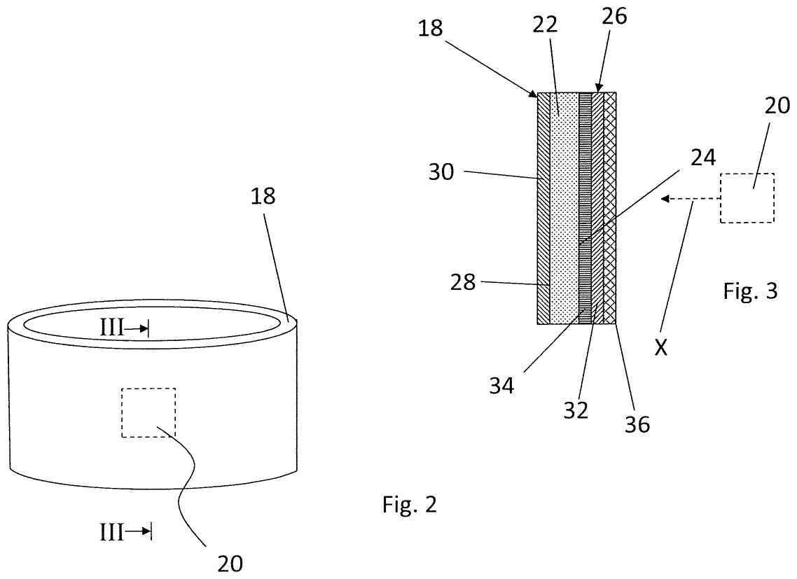

FIG. 2 is a perspective illustration of one of the sensor arrangements;

FIG. 3 is a section through a cover element of the sensor arrangement;

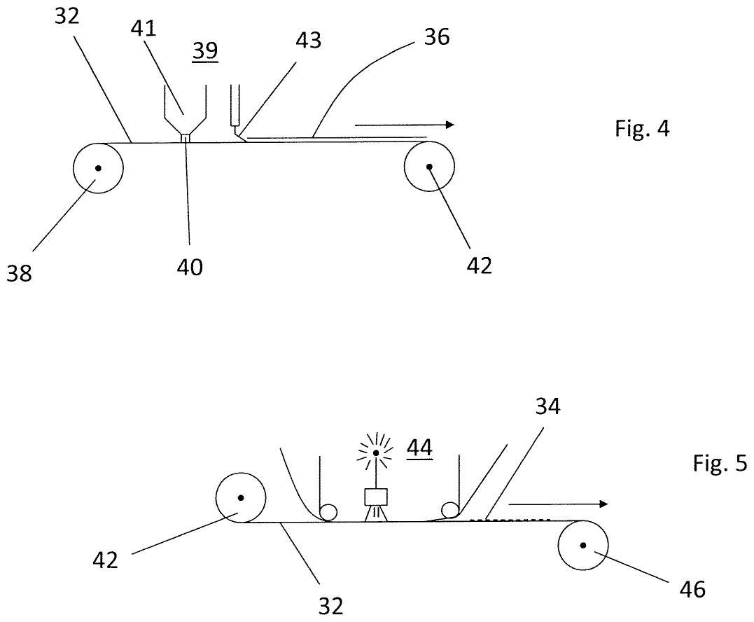

FIG. 4 shows a first step during production of the cover arrangement;

FIG. 5 shows a second step during production of the cover arrangement;

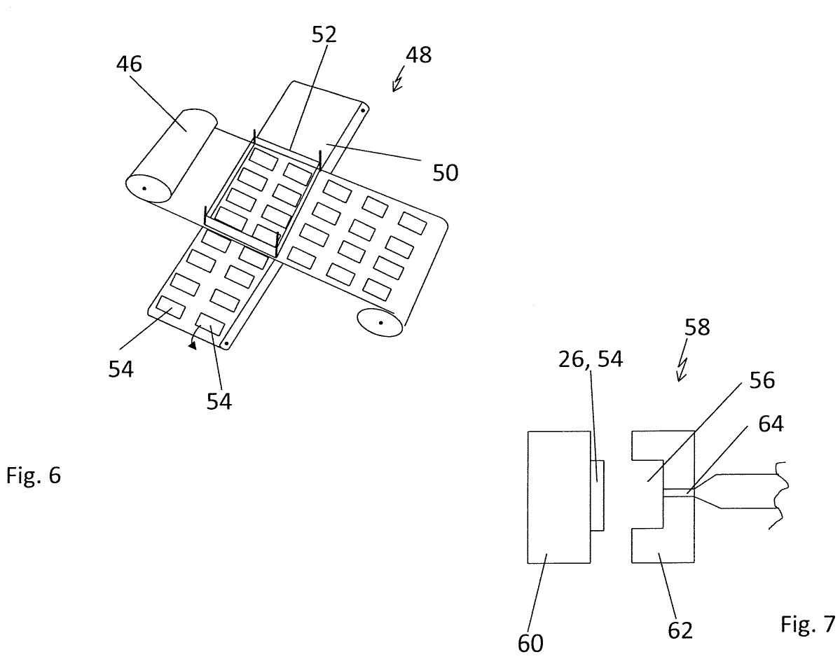

FIG. 6 shows a third step during production of the cover arrangement; and

FIG. 7 shows a fourth step during production of the cover arrangement.

The drawing illustrates a motor vehicle 10, which is realized as a station wagon in the case at hand and which has a vehicle roof 12 covering a vehicle interior. At the front, i.e., in the direction of the vehicle front, vehicle roof 12 ends in a wind-shield 14.

Vehicle roof 12 is an injection-molded part made of a plastic material, which is a polycarbonate material in the case at hand.

Motor vehicle 10 is designed in such a manner that it allows autonomous or semi-autonomous driving. For this purpose, four sensor arrangements 16, which are environment monitoring sensors, are realized on vehicle roof 12. This makes the sensor arrangements what is referred to as LiDAR sensors, which use laser light as electromagnetic radiation.

Sensor arrangements 16 are essentially identical and, as illustrated in FIGS. 2 and 3, each comprise a cover element 18 forming a sensor housing in which a sensor element 20 is disposed, sensor element 20 emitting the laser light in a measuring direction X, the laser light passing through the cover element and being used to monitor the vehicle environment.

Cover element 18 comprises an injection-molded core 22 made of a polycarbonate material and carrying a film arrangement 26 on its inner side 24, which faces sensor element 20. On its outer side 28, which faces the vehicle environment, polycarbonate core 22 is provided with a protective coating 30, which is a protection against scratching, weather and chemicals and is formed by a paint system.

Film arrangement 26 comprises a film 32 made of a polycarbonate material and provided with conductor tracks 34, which are a heating means for cover element 18, on its side facing core 22. An anti-reflection coating 36 made of a polysiloxane compound is applied to film 32 on the side facing sensor element 20. Anti-reflection coating 36 is structured to increase its anti-reflection effect. In particular, it has what is known as a moth-eye structure, which is produced by plasma etching. In the case at hand, anti-reflection coating 36 has an anti-reflection effect for electromagnetic radiation in the wavelength range between 800 nm and 1200 nm. Electromagnetic radiation having wavelengths greater than 1200 nm and less than 800 nm is reflected by anti-reflection coating 36.

The production of cover element 20 of sensor arrangement 16 is explained below with reference to highly schematized FIGS. 4 to 7.

In a first step, film 32, which has a thickness between 100 μm and 400 μm, is provided on a roller 38 and unwound therefrom. At a coating station 39, one side of film 32 is then extensively coated with material 40, which is produced based on polysiloxane and stored in a container 41, to form anti-reflection coating 36, applied material 40 being evenly distributed on film 32 by means of a doctor blade 43. Once anti-reflection coating 36 has been formed and structured by plasma etching, film 32, together with anti-reflection coating 36, is wound onto a second roller 42. Roller 42 is then made available to another processing station 44. There, film 32 provided with anti-reflection coating 36 is unwound from second roller 42 and provided with conductor tracks 34 and contact points on the side facing away from anti-reflection coating 36. In the case at hand, this happens by transfer printing, laser radiation being used for the hardening process. Alternatively, however, the conductor tracks can also be applied by screen printing, dispensing, hot stamping or the like. Film 32 provided with conductor tracks 34 including contact points and with anti-reflection coating 36 is then wound onto a third roller 46. Roller 46 is made available to a cutting station 48, where film 32 provided with conductor tracks 34 and anti-reflection coating 36 is unwound and cut to size on a conveyor belt 50 by means of a die cutting tool 52, which results in film cuts 54 corresponding to film arrangement 26 disposed on cover element 18 in question.

Film cuts 54 can be removed from conveyor belt 50 by means of a transfer robot and can be placed in a mold cavity 56 of an injection mold 58 as an insert. Injection mold 58 comprises a first tool half 60 and a second tool half 62. The two tool halves 60 and 62 define and limit mold cavity 56 when injection mold 58 is closed. Film cut 54 is mounted on tool half 60 while injection mold 58 is open. Subsequently, injection mold 58 is closed so as to form mold cavity 56, whereupon polycarbonate material for forming polycarbonate core 22 of cover element 18 is introduced into mold cavity 56 via a gate runner 64.

After hardening of the polycarbonate material in mold cavity 56, injection mold 58 is opened and the cover element comprising film cut 54, i.e., film arrangement 26, and core 22 is demolded.

In a last method step, core 22 is provided with protective coating 30 on the side facing away from film arrangement 26. Protective coating 30 can be applied in one or two layers. The material used is formed by a paint system which hardens thermally or with the aid of UV radiation. It is applied by spraying or flow coating.

Resulting cover element 18 can be used to produce sensor arrangement 16.

### REFERENCE SIGNS

10 motor vehicle

12 vehicle roof

14 windshield

16 sensor arrangement

18 cover element

20 sensor element

22 core

24 inner side

26 film arrangement

28 outer side

30 protective coating

32 film

34 conductor tracks

36 anti-reflection coating

38 roller

39 coating station

40 material

41 container

42 roller

43 doctor blade

44 processing station

46 roller

48 cutting station

50 conveyor belt

52 die-cutting tool

54 film cut

56 mold cavity

58 injection mold

60 tool half

62 tool half

64 gate runner

1. A sensor arrangement of a motor vehicle, the sensor arrangement comprising:
a sensor element emitting electromagnetic radiation in a measuring direction to determine a measurement signal, and
a cover element disposed in front of the sensor element in the measuring direction and being an injection-molded plastic part permeable to the electromagnetic radiation and having an outer side facing a vehicle environment and an inner side facing the sensor element, and
a heating means comprising conductor tracks,
wherein the conductor tracks are applied to a film formed to the inner side of the cover element during production of the cover element by injection-molding, the film with the conductor tracks thus forming an insert of the injection-molded cover element, the conductor tracks being located on the side of the film facing away from the sensor element.

2. The sensor arrangement according to claim 1, wherein the film has an anti-reflection coating on its side facing away from the conductor tracks.

3. The sensor arrangement according to claim 2, wherein the anti-reflection coating is reflective for electromagnetic radiation having a wavelength outside of a specific wavelength spectrum.

4. The sensor arrangement according to claim 2 wherein the anti-reflection coating has a surface structure.

5. The sensor arrangement according to claim 1, wherein the plastic of the cover element is made of a polycarbonate material.

6. The sensor arrangement according to claim 1, wherein the film comprises a polycarbonate material.

7. The sensor arrangement according to claim 1, wherein the cover element is provided with a protective coating on its outer side.

8. The sensor arrangement according to claim 7, wherein the protective coating has a refractive index less than that of the plastic material of the cover element.

9. The sensor arrangement according to claim 1, wherein the cover element is an outer skin element of a vehicle roof.

10. The sensor arrangement according to claim 1, wherein the cover element is an outer skin element of a vehicle front or of a vehicle rear.

11. A method for producing a cover element of a sensor arrangement of a motor vehicle, the method comprising the following steps:
providing a film having a first side and a second side;
applying conductor tracks to the first side of the film;
introducing the film with the conductor tracks into a mold cavity of an injection mold;
filling the mold cavity of the injection mold with a plastic material;
hardening the plastic material in the mold cavity to form the cover element having the film molded thereon; and
demolding the cover element having the film molded thereon.

12. The method according to claim 11, wherein an anti-reflection coating is applied to the second side of the film.

13. The method according to claim 11, wherein the anti-reflection coating is subjected to a structuring process.

14. The method according to claim 12, wherein the film is unwound from a first roller and then wound onto a second roller to apply the anti-reflection coating.

15. The method according to claim 14, wherein the film is unwound from the second roller to apply the conductor tracks.

16. The method according to claim 11, wherein after demolding, the cover element is provided with a protective coating on the side facing away from the film.

17. The method according to claim 13, wherein the structuring process is a plasma etching process.
